(19) United States
(12) Patent Application Publication
(10) Pub. No.: US 2026/0351682 A1
(43) Pub. Date: Nov. 5, 2026

(54) FAST PREPARATION METHOD FOR PRODUCING LITHIUM ARGYRODITE SOLID ELECTROLYTE FOR SOLID-STATE BATTERIES

(71) Applicant: TECHNISCHE UNIVERSITEIT DELFT, Delft (NL)

(72) Inventors: Marnix WAGEMAKER, Delft (NL); Ajay AJAY GAUTAM, Delft (NL)

(73) Assignee: TECHNISCHE UNIVERSITEIT DELFT, Delft (NL)

(21) Appl. No.: 19/496,685

(22) PCT Filed: Jun. 13, 2024
(86) PCT No.: PCT/NL2024/050315

§ 371 Date: Dec. 23, 2025

(30) Foreign Application Priority Data
Jun. 23, 2023 (NL) 2035165

(51) Int. Cl. H01M 10/0585; H01M 10/0525

(52) U.S. Cl. CPC H01M 10/0585; H01M 10/0525; H01M 2300/008

(57) ABSTRACT

The present invention relates in a first aspect to a battery, typically a secondary cell battery which can be recharged, in a second aspect to a an improved electrolyte for such a solid-state battery, that is, a medium that comprises ions and that is charge conducting through the movement of those ions, rather than conducting through electrons, such as in the battery, in a third aspect to a method of producing such a solid crystalline electrolyte, and in a fourth aspect to a product obtained by said method. The present invention provides and improved battery performance.

### FIELD OF THE INVENTION

The present invention relates in a first aspect to a battery, typically a secondary cell battery that can be recharged, in a second aspect to a an improved electrolyte for such a solid-state battery, that is, a medium that comprises ions and that is charge conducting through the movement of those ions, rather than conducting through electrons, such as in the battery, in a third aspect to a method of producing such a solid crystalline electrolyte, and in a fourth aspect to a product obtained by said method. The present invention provides and improved battery performance.

### RELATED APPLICATIONS

The present application claims the benefit of priority from Dutch Patent Application NL2035165, filed on Jun. 23, 2023, in the name of Technische Universiteit Delft, The Netherlands.

The entire contents of the above-referenced applications and of all priority documents referenced in the Application Data Sheet filed herewith are hereby incorporated by reference for all purposes.

### BACKGROUND OF THE INVENTION

The present invention is in the field of a secondary electrochemical cell, commonly referred to as a rechargeable battery. Such a cell is capable of generating electrical energy from (electro) chemical reactions or using electrical energy to cause (electro) chemical reactions, such as when recharged. The electrochemical cells which generate an electric current are called voltaic cells or galvanic cells and those that generate chemical reactions, via electrolysis for example, are called electrolytic cells. The present invention is focused on galvanic cells, such as a battery. A battery may consist of one or more cells. Cells can be connected in parallel, in series, or a combination thereof. When discharged/recharged such a cell effectively is both a galvanic cell and an electrolytic cell. It is used to store electric energy upon charging, and to deliver electric energy during discharging.

A single valence ion battery, such as lithium-ion battery or sodium-ion battery, may be used for energy storage, which may be a type of rechargeable battery. These single valence cation batteries are widely used, such as for portable electronics, electric vehicles, and electrical energy storage devices. In the batteries, lithium ions may move back and forth, from the negative electrode to the positive electrode during discharge, and vice versa when charging. For rechargeable cells, the term cathode designates the electrode where reduction is taking place during the discharge cycle; for lithium-ion cells, the positive electrode is referred to as cathode, which typically is the lithium-based one. Li-ion batteries may use an intercalated lithium compound as one electrode material. The batteries have certain advantages over other electric energy storage devices, such as a relatively high energy density, low self-discharge, and no memory effect. Typical density characteristics are a specific energy density of up to 250 Wh/kg, a volumetric energy density of up to 700 Wh/l, and a specific power density of up to 1500 W/kg. The performance of the batteries can be improved, such as in terms of life extension, energy density, safety, costs, and charging speed.

The present invention in particular relates to a solid state battery. A solid-state battery that uses solid electrodes and a solid electrolyte, instead of the typically used liquid or polymer gel electrolytes, such as those found in lithium-ion batteries. Several drawbacks have prevented widespread application of these batteries. On the other hand solid-state batteries are considered to provide solutions for many problems typically occurring in liquid Li-ion batteries, such as flammability, limited voltage, lithium dendrite growth, unstable solid-electrolyte interphase formation, poor cycling performance and strength. Materials proposed for use as solid electrolytes in solid-state batteries include ceramics, and solid polymers. These materials are potentially safer, with higher energy densities, but at a much higher cost, compared to the liquid variant. Challenges to widespread adoption include energy and power density, durability, material costs, sensitivity, stability, capacity, ion depletion, charging speed, and cycling performance of power supply units. In addition prior art devices tend to have too many inactive parts and/or too large inactive part. Some of these devices have internal mechanical stress, a lower capacity, and shortening of cycle life. In this respect Si could be considered as anode material, but it is often not suited in view of its large volumetric expansion when forming LiₓSi_{y} (such as Li_{4.4}Si).

Some materials are considered for solid-state electrolytes, such as argyrodite; the term may refer to an uncommon silver germanium sulphide mineral with formula Ag₈GeS₆. However, this is not the material of interest. The argyrodite group of minerals encompasses various other sub-groups, other than the Ag-comprising one. The term argyrodite is thus also used for other materials with a similar crystal structure, in particular lithium based argyrodite-type materials, which actually have received interest from researchers as a potential solid-state electrolyte for lithium-ion batteries. These materials provide some improvements over e.g., prior art materials, such as garnet-type materials, or NASICON-like, e.g. in terms of ionic conductivity. However, production methods are typically expensive, and a quality of the obtained materials is still sub-optimal. Also, only relatively large particles are produced, typically in the order of 10 μm or orders of magnitude larger.

Li-ion batteries usually consist of a LiCoO₂ cathode and graphite anode. During charging Li ions are transported towards and absorbed by the electrode, typically a graphite electrode, by intercalation of the Li ions in planar atomic graphite structure. The specific capacity of materials used in these batteries is in the order of 372 mAh/g (Ashuri et al., Nanoscale, vol. 8, 74 (2016)). It is typical to use one Li-ion or Na-ion salt, and sometimes to use two salts, of which one is than a dominant salt, with a higher concentration, typically LiPF6. Typically, a liquid Li-ion battery electrolyte further comprises at least two solvents, for example EC/DMC, and a few additives.

If an electric potential is applied to the battery cations are drawn to the electrode that has an abundance of electrons, while the anions are drawn to the electrode that has a deficit of electrons. The movement of anions and cations in opposite directions within the battery amounts to an electrical current. So, when electrodes are in contact with the electrolyte, and a voltage is applied to the electrodes or is obtained from the electrodes, the electrolyte will conduct charges. An electrochemical reaction will occur as a consequence, at the cathode, providing electrons to the electrolyte and the electrolyte providing ions to the electrodes. Another electrochemical reaction will occur at the anode, consuming electrons from the electrolyte. As a result, a charge distribution, such as in the form of a negative charge cloud, which typically also has a gradient, forms around the cathode, and likewise a positive charge forms around the anode. Without the ions, the charges around the electrode would slow down continued electron flow; diffusion of charged species to the other electrode is limited. In batteries, two materials with different electron affinities are used as electrodes; electrons flow from one electrode to the other outside of the battery, while inside the battery the circuit is closed by the electrolyte's ions. Here, the electrode reactions may convert chemical energy to electrical energy.

Incidentally, Huang Wenze et al. (https://doi.org/10.1039/D0MA00115E) recites the conduction mechanism in oxygen-substituted lithium conductors composed of the Li_{6.15}Al_{0.15}Si_{1.35}S₆₋ₓOₓ (LASSO) system, a member of the argyrodite-type family and has superionic conductivities, making it suitable for all-solid-state batteries. The crystal structures, ionic conductivities, and electrochemical properties of these systems were examined using powder X-ray and neutron diffractometry combined with impedance spectroscopy and cyclic voltammetry measurements. WO 2022/210471 A1 recites a solid electrolyte containing Li, P, S, a halogen, and element M (where M represents at least one element from among silicon (Si), tin (Sn), antimony (Sb), germanium (Ge), and boron (B)), the solid electrolyte including a crystal phase that has an argyrodite-type crystal structure. The molar ratio S/(P+M) of S relative to the total of P and element M satisfies 3.5. US 2022/166056 A1 recites a lithium-argyrodite ionic superconductor containing a halogen element and a method for preparing the same, wherein an argyrodite-type crystal structure can be maintained and lithium ion conductivity can be improved by combining specific elements at a specific molar ratio. US 2021/119247 A1 recites a sulfide-based lithium-argyrodite ion superconductor containing multiple chalcogen elements and a method for preparing the same. More specifically, provided are a sulfide-based lithium-argyrodite ion superconductor containing multiple chalcogen elements and a method for preparing the same that are capable of significantly improving lithium ion conductivity by substituting a sulfur(S) element in a PS43-tetrahedron with a chalcogen element such as a selenium (Se) element, other than the sulfur(S) element, while maintaining an argyrodite-type crystal structure of a sulfide-based solid electrolyte represented by Li6PS5Cl.

The present invention therefore relates to an improved power supply unit, in particular a battery, which solves one or more of the above problems and drawbacks of the prior art, providing reliable results, without jeopardizing functionality and advantages.

### SUMMARY OF THE INVENTION

It is an object of the invention to overcome one or more limitations of power supply units of the prior art and methods of making these and at the very least to provide an alternative thereto. The present invention provides an improved electrolyte for a solid-state battery, such as in terms of electrolytes with higher ion conductivity, and a faster and more energy efficient synthesis method of the solid electrolyte material. High conductivities are considered to be required for fast charging, and for high power applications, and more generally provides a more efficient use of the electrode capacities. Existing synthesis methods are time- and energy consuming (such as an annealing time of seven to fourteen days at 550 °C), and consume more energy, while producing only small amounts of solid electrolytes. Inventors developed a synthesis method that can produce the materials in a much more efficient way. It is noted that Lithium argyrodite superionic conductors have gained attention as potential solid electrolytes for all-solid-state batteries, in view of their high ionic conductivity, and ease of processing. These materials provide the ability to introduce halides (Li₆₋ₓPS₅₋ₓHa₁₊ₓ, Hal=Cl, Br and I) into the argyrodite crystal structure, which may greatly impact the lithium distribution over a wide range of the accessible crystal sites. Also, a structural disorder between the S²⁻ and Hal⁻ anion on Wyckoff 4d site is provided. Both are found to strongly influence ionic conductivity. In the present invention the argyrodite synthesis method is different from the prior art and leads to an increase of the (therefore higher) ionic conductivity as well as fast crystallization method of argyrodites family. Inventors specifically investigated the effect of bromide substitution on lithium argyrodite (Li₆₋ₓPS₅₋ₓHal₁₊ₓ, Hal=Cl, Br, I, Cl_{y}Br_{1-y}, and Cl_{0.33}Br_{0.33}I_{0.33} with a range of 0.0≤x≤0.5) and engineered structural disorder by changing the synthesis protocol. A correlation was found between lithium substructure, structural disorder, and ionic transport, e.g. using X-ray diffraction, neutron diffraction, and electrochemical impedance spectroscopy. Inventors found that higher ionic conductivity is can obtained with a lower average negative charge on the 4d site, located in the centre of the Li⁺ “cage”, as a result of the partial replacement of S²⁻ by halide and mixed halide. This promoted Li-ion diffusivity across the unit cell. Additionally and extra T4 Li⁺ site was identified, which opened the additional pathway for long-range lithium-ion diffusion. The ionic conductivity is increased up to 9-10 mS cm⁻¹, for exemplary quenched Li_{5.5}PS_{4.5}Br_{1.5}, having the relatively highest degree of structural disorder, which is an 11-fold improvement compared to slow-cooled Li₆PS₅Br having the relatively lowest degree of structural disorder. Moreover, modifying the synthesis method for chloride-rich argyrodite to include increased pressure during the synthesis and a higher chloride content resulted in a 5-fold improvement in ionic conductivity compared to Li₆PS₅Cl. Structural disorder and halide substitution are found to impact the lithium substructure, and transport properties, which may be tuned through the present synthesis method, e.g. for achieving higher ionic conductivity. In a first aspect the present invention relates to an electrolyte for a solid-state battery comprising at least one solid single crystalline electrolyte wherein the solid single crystalline electrolyte is selected from at least one of A₆₋ₓZE₅₋ₓHal₁₊ₓ and A₆₊ₓZ₁₋ₓM₁₋ₓE₅₋ₓHal₁₊ₓ, wherein A is selected from Li, Na, and first combinations thereof, wherein Z is selected from P, As, Sb, and second combinations thereof, wherein M is selected from Si, As, Ge, As, Sn, and Sb, and third combinations thereof, wherein E is selected from O, S, Se, Te, and fourth combinations thereof, wherein Hal is selected from Cl, Br, I, or mixed halide, that is fifth combinations thereof, and wherein x is from <−1;1.0], in particular from <−1;0.75], in particular wherein x is not from −0.9-−1. The term solid single-phase crystalline electrolyte as used herein refers to a solid electrolyte which is single-phase crystalline. The term crystalline is a well-known chemical term for a solid material which constituents (such as atoms, molecules, or ions) are arranged in a highly ordered microscopic structure, forming a crystal lattice that extends in all directions. Three forms or main categories of crystalline are i) single crystalline, also known as monocrystalline, ii) polycrystalline, and iii) amorphous. In a single crystalline material the crystal lattice of the entire sample is continuous and unbroken to the edges of the sample, with no grain boundaries. The atoms are in a near-perfect arrangement. In polycrystalline materials the material is composed of many microscopic crystals, which are called crystallites or grains. Although a polycrystal is a crystal with a periodic arrangement of atoms, the polycrystal as a whole does not have a periodic arrangement of atoms, because the periodic pattern is broken at the grain boundaries. Within the group of polycrystalline materials there may be some variety in the number of grain types. If a polycrystal consists of one type of grains, the particular polycrystal is called a single-phase polycrystal. If a polycrystal consists of more types of grains, such as for example three types, such polycrystal is called a three-phase polycrystal. Solids that are neither single crystalline nor polycrystalline, such as glass, are called amorphous solids, and have no periodic arrangement, not even microscopically. The present invention relates to a solid electrolyte which is single phase crystalline, which is thus arranged in a particular structure with higher lithium-ion mobility in a unit cell. A single crystalline material may be in the form of a mixed crystal. A mixed crystal refers to a crystal which comprises two or more elements, also known as ions, or molecules, which occupy different sites of the crystal lattice. Such elements can replace each other in the crystal lattice due to their similar molecular structure and shape. The abbreviations Fe, Mn, Li, Na, Co, Ni, Al, Sn, Mg, Ag, P, As, Sb, In, Si, B, C, N, Ge, O, H, Sn, S, Se, Te, F, Cl, Br and I, as used in the present disclosure, refer to the particular chemical elements which are known from the periodic table of elements, and refer e.g. to Lithium (Li), Sodium (Na), Phosphorus (P), Arsenic (As), Antimony (Sb), Silicon (Si), Arsenic (As), Germanium (Ge), Tin (Sn), Oxygen (O), Sulphur(S), Selenium (Se), Tellurium (Te), Chlorine (Cl), Bromine (Br) and Iodine (I). Terms like alloy, transition metal and transition metal alloy as used herein are known to the skilled person. An allow is the common chemical name for a mixture of chemical elements of which at least one is a metal, which results in an impure substance that retains the characteristics of a metal. Transition metals, also known as transition elements, are the chemical elements of the d-block of the periodic table (groups 3 to 12). It is demonstrated that solid single phase crystalline electrolytes of the invention have great benefits over electrolytes from the prior art, e.g. in terms of their ionic conductivity.

In a second aspect the present invention relates to a solid state battery comprising at least one first electrode, at least one second electrode, in between the first and second electrode and in contact with the first and second electrode at least one solid state single Phase crystalline electrolyte as taught herein.

In a third aspect the present invention relates to a method of producing a solid crystalline electrolyte, wherein the to be produced solid electrolyte comprises at least one of A₆₋ₓZE₅₋ₓHal₁₊ₓ and A₆₊ₓZ₁₋ₓM₁₋ₓE₅₋ₓHal₁₊ₓ, wherein A is selected from Li, Na, and first combinations thereof, wherein Z is selected from P, As, Sb, and second combinations thereof, wherein M is selected from Si, Ge, As, Sn, and Sb, and third combinations thereof, wherein E is selected from O, S, Se, Te, and fourth combinations thereof, wherein Hal is selected from Cl, Br, I, and fifth combinations thereof, and wherein x is from <−1;1.0], in particular from <−1;0.75], in particular wherein x is not from −0.99 to −1, providing precursors in substantially molar amounts and forming a mixture thereof, wherein precursors are selected from A, M, Z, E, combinations of ZE, and from AHal, in particular wherein E is provided in an excess amount of 1.01-1.2 times the molar amount, milling the mixture during a milling time therewith obtaining a milled mixture, heating the milled mixture at an elevated temperature during a heating time therewith forming electrolyte, and cooling the heated mixture therewith obtaining solid crystalline electrolyte. The phrase “molar amount” as used herein is a chemical expression which is well known to the skilled person. It refers to the expression of the amount of a material, compound or element in moles (mol), and is known to be calculated by dividing mass (g) by the molar mass (g/mol) of the material, compound or element. The term “substantially” herein, will be understood by the person skilled in the art, and may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The terms heating and cooling are known to the skilled person. Both the heating as well as cooling may comprise or consist of any possible way to heat the milled mixture or to cool the heated mixture. Cooling is preferably carried out in the form of quenching or in a form comprising quenching. Quenching is a known term, e.g. from material science, and refers to rapid cooling of a material in a fluid, such as water, liquid nitrogen, oil, polymer, other fluids, or in air. Quenching is preferably carried out in a fluid, preferably in water or liquid nitrogen, in particular in water. In general, quenching prevents potentially undesired low-temperature processes by reducing the window of time during the cooling process. The inventors synthesized Bromide, Chloride and Iodide-enriched lithium argyrodites Li₆₋ₓPS₅₋ₓHal₁₊ₓ with compositions ranging from x=0.0 to 0.5 using two cooling methods, that is executed chemical reactions to form a more complex molecule from chemical precursors. It was found that cooling method controlled the halide structural disorder as on 4d site in the Li₆₋ₓPS₅₋ₓHal₁₊ₓ series. Rietveld refinement against X-ray diffraction, and neutron diffraction is analyzed the occupancies of cations and anions, and lithium substructure. As the halide content increased, the Li⁺ ions move away from the center of the cage (4d site), as indicated by Rₘₑₐₙ (Average mean lithium distance) and higher long-range connection between lithium cages. In the case of Bromide-rich argyrodite, the slow-cooled method resulted in an increase in ionic conductivity from 0.78 mS cm⁻¹ (Li₆PS₅Br) to 6.2 mS cm⁻¹ (Li_{5.5}PS_{4.5}Br_{1.5}), while the quenched method showed an increase from 3.21 mS cm⁻¹ (Li₆PS₅Br) to 9.0 mS cm⁻¹ (Li_{5.5}PS_{4.5}Br_{1.5}). These findings demonstrate how chemical changes and synthesis conditions affect the structural disorder and lithium substructure in order to tailor the transport properties of these materials. It is also demonstrated that the method of the present invention provides for a synthesis method which is faster and more efficient in terms of time needed as well as in terms of costs. In a fourth aspect the present invention relates to a product obtained by the method as taught herein, wherein the product is crystalline, in particular single phase crystalline material.

In a fifth aspect the present invention relates to a system for power supply comprising at least one solid-state battery as taught herein.

The present invention provides a solution to one or more of the above mentioned problems and overcomes drawbacks of the prior art. In addition, a very fast synthesis is provided, typically an order of magnitude faster.

Advantages of the present description are detailed throughout the description.

### DETAILED DESCRIPTION OF THE INVENTION

In an exemplary embodiment of the present solid electrolyte for a solid-state battery, the solid electrolyte is in the form of single crystalline particles, wherein the particles have a size distribution with an average size of 200-5000 nm, in particular 300-1000 nm, and wherein a standard deviation of the size distribution is 2-20% relative to the average size, in particular 5-12% relative to the average size, as measured with a Shimadzu SALD-7500nano. The phrase ‘size distribution with an average size’ refers to the way wherein the size of particles is generally described. As using a single average number for describing the average size of particles does not provide information on how much and to what extend the particle sizes are distributed around an average number, the average size normally goes together with a particular standard deviation in order to describe the distribution. The skilled person knows that, next to a certain average number of size, the width of the size distribution provides insight of a particular particle size distribution. A suitable method of measuring the said particle size distribution is by using a Shimadzu SALD-7500nano instrument, which is a laser diffraction particle size instrument, having a measurement range of 7 nm to 800 μm. In an exemplary embodiment of the present solid electrolyte for a solid-state battery, the solid electrolyte is a mixed crystal. A single phase crystalline material may be in the form of a mixed crystal. The term mixed crystal as used herein refers to a crystal which comprises two or more elements, also known as ions, or molecules, which occupy different sites of the crystal lattice. Such elements can replace each other in the crystal lattice due to their similar molecular structure and shape.

In an exemplary embodiment of the present solid electrolyte for a solid-state battery, at least one of first combinations, second combinations, third combinations, fourth combinations, and fifth combination is present, in particular wherein two or three of said combi-nations are present.

The first, second, third, fourth and fifth combinations as used herein refer to the combinations as described in the first aspect of the present invention, wherein A is selected from Li, Na, and first combinations thereof, wherein Z is selected from P, As, Sb, and second combinations thereof, wherein M is selected from Si, As, Ge, Sn, and Sb, and third combinations thereof, wherein E is selected from O, S, Se, Te, and fourth combinations thereof, wherein Hal is selected from Cl, Br, I, and fifth combinations thereof.

In an exemplary embodiment of the present solid electrolyte for a solid-state battery, a unit cell of the solid electrolyte comprises a plurality of crystallographic Hal-sites (Wyckoff 4a), respectively, wherein a first of said crystallographic Hal-site is partly occupied by E and Hal, in particular a Wyckoff 4a Hal-site and a Wyckoff 4d Hal-site, in particular having a crystal site Hal distribution, in particular Hal distribution wherein a first site is occupied for up to 95%, in particular up to 88%, more in particular up to 60%, even more in particular up to 37%, wherein a second site is occupied for more than 5%, in particular for 12-80%, more in particular for 40-75%. In materials science, crystal lattice structures are the primary metrics used to measure the structure property paradigm of a crystal structure. Crystal compounds are understood by the number of various atomic chemical settings, which are associated with Wyckoff sites. In crystallography, a Wyckoff site is a point of conjugate symmetry. Therefore, features associated with the various atomic settings in a crystal can be fed into the input layers of deep learning models. Methods to analyse crystals using Wyckoff sites can help to predict crystal structures. The term crystallographic sites as used herein refers to sites in the crystal lattice, being the positions of elements (atoms, molecules, etc.) within the lattice.

In an exemplary embodiment of the present solid electrolyte for a solid-state battery, the solid single crystalline electrolyte has at least one site disorder of 1-75%, in particular at least one site disorder of 15-70%, more in particular at least one site disorder of 25-65%, such as 30-55%, in particular two or three site disorders. The term site disorder, as used herein, also known as crystallographic disorder, refers to the co-crystallization of more than one rotamer, conformer, or isomer where the centre of mass of each form is identical. As a consequence of disorder, the crystallographic solution is the sum of the various forms. Disorder, in particular anion disorder, thus refers to the random arrangement of various anions within the same crystallographic site. Because of the periodicity of crystals, every object is regularly repeated in three-dimensional space, however in the case of disorder, the orientations of some atoms differ in different unit cells. The synthesis method as developed by the present inventors, was found to control disorder in order to further improvement of the electrolyte of the present invention in a higher ionic conductivity.

In an exemplary embodiment of the present solid electrolyte for a solid-state battery, the solid single crystalline electrolyte has an ion conductivity of >1 mScm⁻¹, in particular of >8 mScm⁻¹, such as of 10-50 mScm⁻¹. The term ion conductivity as used herein refers to a measure of a substance's tendency towards ionic conduction. Ionic conduction means the movement of ions. In most solids, ions rigidly occupy fixed positions, strongly embraced by neighbouring atoms or ions. In other solids, selected ions are highly mobile allowing ionic conduction. Materials like electrolytes for batteries do have this property. Ion conductivity is expressed in Siemens per meter (S/m), and depending on the particular value, ion conductivity can thus also be expressed in milliSiemens (mS/cm), microSiemens (μS/cm), per unit length, etc.

In an exemplary embodiment of the present solid electrolyte for a solid-state battery, the solid single crystalline electrolyte has a crystallinity of >95%, in particular >98%, such as >99%, and/or wherein the unit cell of the solid single crystalline electrolyte has a plurality of A-crystal sites, in particular a Wyckoff T2-site, a Wyckoff T4-site, a Wyckoff T5a site, and a Wyckoff T5 site, wherein at least two of the plurality of A-crystal sites are partly or fully occupied by A, in particular three or four A-crystal sites, and having a crystal site A distribution, in particular an A distribution wherein a first site is occupied for more than 55%, wherein a second site is occupied for 1-25%, in particular for 10-20%, wherein a third site is occupied for less than 26%, in particular 0-10%, and wherein a fourth site is occupied for a remainder of the A-occupation, as determined with neutron diffraction data, in particular from Rietveld refinement thereof, and/or wherein solid single phase crystalline electrolyte has a capacitances of 0.1 to 20×10⁻¹⁰ F cm⁻², in particular of 1 to 10×10⁻¹⁰ F cm⁻², and/or wherein solid single crystalline electrolyte has an α value of 0.89-0.97 represent the bulk transport, grain boundary contribution has not been observed.

The term crystallinity as used herein refers to the degree of structural order in a solid. In a crystal, the atoms and/or molecules are arranged in a regular and periodic way. The degree of crystallinity can have influence on characteristics like hardness, density, transparency diffusion, and higher ionic conductivity.

In an exemplary embodiment of the present solid-state battery, the material of the cathode is selected from Fe comprising cathodes, from Mn comprising cathodes, from Li or Na comprising cathodes, from Co comprising cathodes, from transition metal alloys, from Ni comprising cathodes, in particular from nickel comprising alloys, more in particular from nickel alloys with >75% Ni, such as >80 atom % Ni, and/or wherein the anode comprises a material selected from alloys, in particular from Al-alloys, from Sn-alloys, from Mg-alloys, from Ag-alloys, from Sb alloys, from In alloys, and from silicon alloys (a-Si_{y}Aₓ:Q_{z}), wherein element A is selected from B, C, N, Ge, O, and combinations thereof, wherein element Q is selected from H, F, and combinations thereof, and from silicon, wherein the silicon alloy or silicon is porous for accommodating electrolyte ions, such as Li ions, wherein the silicon alloy or silicon has a porosity from 1-50%, wherein the silicon alloy or silicon is amorphous, and wherein the silicon or silicon alloy is preferably hydrogenated, from conversion-type anode materials, in particular from metal sulphides, metal oxides, metal phosphides, metal nitrides, metal fluorides, and metal selenides, more in particular wherein the metal thereof is a transition metal, from carbon based compounds, such as graphite, and graphene, and from a Li- or Na-metal anode, and/or wherein the at least one first electrode and/or the at least one second electrode comprise a nano-crystalline material.

The term porosity as used herein refers to the fraction of voids per unit volume of the particular material, such as silicon or silicon alloy; or in other words the ratio between the total volume of the pores to the volume of the material as a whole. A volume fraction is expressed in percentage. This may in general easily be determined by techniques such as weight measurement. The term nano-crystalline material as used herein refers to a known category of crystalline materials which are ultrafine-grained single-phase or multiphase polycrystals with grain sizes in the range of 1-100 nm.

In an exemplary embodiment of the present solid-state battery, the battery further comprises at least one separator, wherein the at least one separator is provided in between the at least one solid state crystalline electrolyte and the first or second electrode, respectively.

In an exemplary embodiment of the present solid-state battery, the at least one first electrode has a thickness of 50-500 μm, in particular 100-300 μm, such as 150-250 μm, and/or the at least one second electrode has a thickness of 20-300 μm, in particular 40-200 μm, such as 50-100 μm, and/or wherein the at least one solid state crystalline electrolyte has a thickness of 100-1000 μm, in particular 200-800 μm, such as 300-500 μm.

In an exemplary embodiment of the present method of producing a solid crystalline electrolyte, the milling time is from 10-60 minutes, in particular 20-30 minutes, and/or wherein milling is performed at a rpm of 500-600 rpm, in particular 505-520 rpm, and/or wherein a pressure during formation of the electrolyte is applied, in particular a pressure from 49-500 MPa, in particular 100-200 MPa, during a pressure time of 10-60 seconds, such as 20-40 seconds, wherein the milled mixture is heated to a heating temperature of 400-550 °C, and/or during a heating time of 5-120 minutes, in particular 20-105 minutes, and/or wherein cooling is from the heating temperature to a temperature of 15-30 °C, during a cooling time of 1-30 seconds.

In an exemplary embodiment of the present method of producing a solid crystalline electrolyte, the heating temperature is from 300-750 °C, in particular 400-550 °C, and/or the heating time is from 1-10 minutes, in particular wherein a pre-heated oven at the heating temperature is used.

In an exemplary embodiment of the present method of producing a solid crystalline electrolyte, the precursors are selected according to; A is selected from Li, Na, and first combinations thereof, Z is selected from P, As, Sb, and second combinations thereof, Mis selected from Si, Ge, As, Sn, and Sb, and third combinations thereof, E is selected from O, S, Se, Te, and fourth combinations thereof, Hal is selected from Cl, Br, I, and fifth combinations thereof, in particular wherein precursors are selected from Li, P, S, Si, Cl, Br, and I, and combinations of A, Z, M, E, and Hal, in particular AHal, and ZE, Such as LiHal, and P₄S₁₀, and with the proviso that Li₂S is not selected.

The invention will hereafter be further elucidated through the following examples which are exemplary and explanatory of nature and are not intended to be considered limiting of the invention. To the person skilled in the art it may be clear that many variants, being obvious or not, may be conceivable falling within the scope of protection, defined by the present claims.

### SUMMARY OF THE FIGURES

FIGS. 1-10, 11a-f and 12 show schematic views or representations as well as experimental results of the present invention.

### FIGURES

In the figures:
10 first electrode
20 second electrode
30 solid state electrolyte
41 first separator
42 second separator

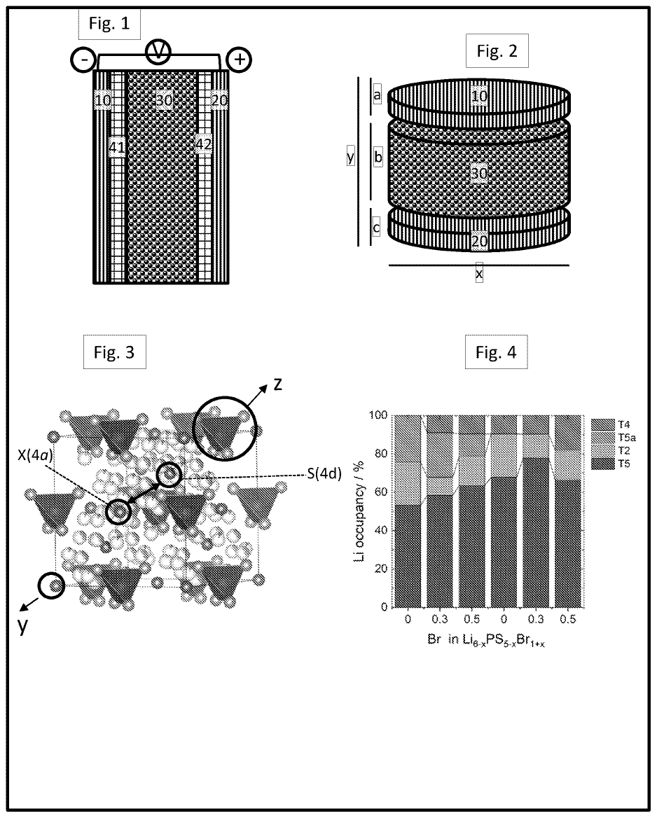

FIG. 1 shows a schematical solid-state battery, with a first electrode 10, typically a Li-comprising electrode, a second electrode 20, typically a composite electrode, optional separators 41,42, such as polymeric and/or ceramic separators, and in the middle a solid-state electrolyte. Separators are mostly not used. The battery provides a voltage V over the +/−electrodes, respectively.

FIG. 2 shows a schematic perspective view of a solid-state battery, with a first electrode 10, the anode, a second electrode 20, the cathode, and in the middle a solid-state electrolyte 30 which is in electrical contact with the first and second electrode. Such a solid-state battery typically has a shape which is substantially cylindrical, or likewise prismatic, and has a particular width x and height y which may vary.

In view of the present disclosure the electrolyte 30 comprises at least one solid single phase crystalline electrolyte wherein the solid single crystalline electrolyte may comprise at least one of A₆₋ₓZE₅₋ₓHal₁₊ₓ and A₆₊ₓZ₁₋ₓM₁₋ₓE₅₋ₓHal₁₊ₓ, wherein A is selected from Li, Na, and first combinations thereof, wherein Z is selected from P, As, Sb, and second combinations thereof, wherein M is selected from Si, As, Ge, Sn, and Sb, and third combinations thereof, wherein E is selected from O, S, Se, Te, and fourth combinations thereof, wherein Hal is selected from Cl, Br, I, and fifth combinations thereof, and wherein x is from <−1;1.0], in particular from <−1;0.75], in particular wherein x is not from −0.99-−1.

The material of the cathode, which is second electrode 20, may be selected from Fe comprising cathodes, from Mn comprising cathodes, from Li or Na comprising cathodes, from Co comprising cathodes, from transition metal alloys, from Ni comprising cathodes, in particular from nickel comprising alloys, more in particular from nickel alloys with >75% Ni, such as >80 atom % Ni;

The material of the anode, which is first electrode 10, may or may in addition comprise a material selected from alloys, in particular from Al-alloys, from Sn-alloys, from Mg-alloys, from Ag-alloys, from Sb alloys, from In alloys, and from silicon alloys a-Si_{y}Aₓ:Q_{z}, wherein element A is selected from B, C, N, Ge, O, and combinations thereof, wherein element Q is selected from H, F, and combinations thereof, and from silicon, wherein the silicon alloy or silicon is porous for accommodating electrolyte ions, such as Li ions, wherein the silicon alloy or silicon has a porosity from 1-50%, wherein the silicon alloy or silicon is amorphous, and wherein the silicon or silicon alloy is preferably hydrogenated, from conversion-type anode materials, in particular from metal sulphides, metal oxides, metal phosphides, metal nitrides, metal fluorides, and metal selenides, more in particular wherein the metal thereof is a transition metal, from carbon based compounds, such as graphite, and graphene, and from a Li- or Na-metal anode.

First electrode 10 and/or second electrode 20, may or may in addition comprise a nano-crystalline material.

In solid-state batteries the electrolyte may function as separator between the anode and the cathode. However, the solid-state battery may further comprise at least one separator. Optional additional separators are not shown in FIG. 2, but are shown in schematic solid-state battery of FIG. 1 (41, 42). Such optional at least one separator is provided in between electrolyte 30 and the first 10 or second electrode 20.

First electrode 10 preferably has a thickness a of 50-500 μm, in particular 100-300 μm, such as 150-250 μm.

Second electrode 20 preferably has a thickness b of 20-300 μm, in particular 40-200 μm, such as 50-100 μm.

Electrolyte 30 preferably has a thickness c of 100-1000 μm, in particular 200-800 μm, such as 300-500 μm.

FIG. 3 shows a schematic representation of the crystal structure of an argyrodite-type Li₆PS₅X. In this particular example the crystal structure of Li₆PS₅Br is shown in an anion ordered state with Br⁻ located on the Wyckoff 4a site and the sulphide anion (S²⁻) on the Wyckoff 4d site. The crystal structure is shown in the ordered structure with space group F-43m; the halide ions arrange in a face-centred cubic lattice (Wyckoff position 4a) with PS₄³⁻ polyhedra located in the octahedral voids (P on Wyckoff 4b and S on Wyckoff 16e) and a “free” S²⁻ (not bound in polyhedra) in half of the tetrahedral sites, Wyckoff 4d. Li⁺ forms an arrangement similar to a cage around the 4d site. In this particular example the letters y and z represent partial substitutes in the lattice structure: y represents partially substituted S>Se, and z represents partially substituted P<Si, Ge, Sn, As.

FIG. 4 shows the occupancy of various Li sites in the argyrodite series by quenching and slow cooling method as a function of bromide content. The left-side three bars (0, 0.3 and 0.5) represent quenching as a cooling method, the right-side three bars (0, 0.3 and 0.5) represent slow cooling as a cooling method.

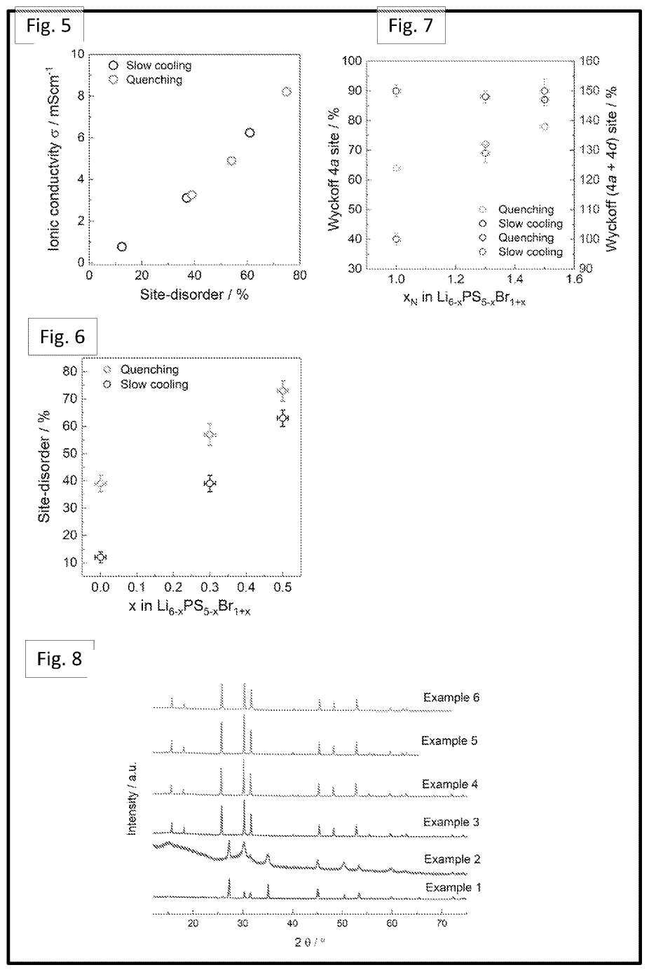

FIG. 5 demonstrates the ionic conductivity as a function of % of site disorder. The measurement was carried out at room temperature and relates to an example electrolyte of Li₆PS₅Br with a Br⁻/S²⁻ site-disorder. The obtained room temperature conductivities are demonstrated in FIG. 5 as a function of the Br⁻/S²⁻ site-disorder. It is clearly demonstrated that increasing disorder leads to an improvement, that is, an increase of the ionic conductivity.

FIG. 6 demonstrates the site-disorder as a function of % Br content in lithium argyrodite with two cooling methods. Slow-cooled samples (Li₆PS₅Br) have a lower site-disorder, as determined by Rietveld refinements of the neutron diffraction patterns. As the total Br content increases, the site-disorder increases, starting from 12% at x=0.0 and reaching 63% at x=0.5 for the slow-cooled method. The quenched method has an even higher site-disorder, starting from 39% at x=0.0 to 72% at x=0.5, most likely because fast cooling “freezes in” the higher site-disorder that is achieved at higher temperatures.

FIG. 7 shows percentage of Br content distributed across Wyckoff 4a sites, and total Br content in each composition (Li₆₋ₓPS₅₋ₓBr₁₊ₓ) as a function of x.

FIG. 8 demonstrates the XRD spectra according to an example electrolyte Li_{5.5}PS_{4.5}Cl_{1.5} which was synthesized by the method of the present invention under different pressures (MPa). The electrolyte was synthesized under 98, 245 and 490 MPa, respectively. The bottom lines 1-3 represent the electrolyte synthesized under 98 MPa, the line called example 4 represents the electrolyte synthesized under 245 MPa, and the two lines 5 and 6 on top represent the electrolyte synthesized under 490 MPa. The different examples relate to different approaches to produce the particular electrolytes. First a hand press was used at different pressures, followed by a heating step of 500 °C for 15 minutes.

Example 1 shows XRD pattern of initial precursor Li₂S, P₂S₅, LiCl Example 2 shows XRD pattern of 3 cycles (15 min) ball milling (BM) samples of Li₂S, P₂S₅, LiCl.

Example 3 shows XRD pattern of 3 cycles (15 min) BM precursors, press the powder manually. For the first three examples hand press was used at 98 MPa pressure to form the pellet and was then heated at 500 C for 15 minutes to form the crystalline Li_{5.5}PS_{4.5}Cl_{1.5}.

Example 4 shows XRD pattern of 3 cycles (15 min) BM precursors, pressing of the powder was performed manually. For example 4 a hand press was used at 245 MPa pressure to form the pellet and was then heated at 500 C for 15 minutes to form the crystalline Li_{5.5}PS_{4.5}Cl_{1.5}.

Example 5 shows XRD pattern of 3 cycles (15 min) BM precursors, pressing of the powder was performed manually. For example 5 a hand press was used at 490 MPa pressure to form the pellet and was then heated at 500 C for 15 minutes to form the crystalline Li_{5.5}PS_{4.5}Cl_{1.5}.

Example 6 shows a repetition of Example 5.

It is demonstrated that when the pressure as used during the synthesis method is increased, the intensity (counts) of the XRD spectrum increases accordingly.

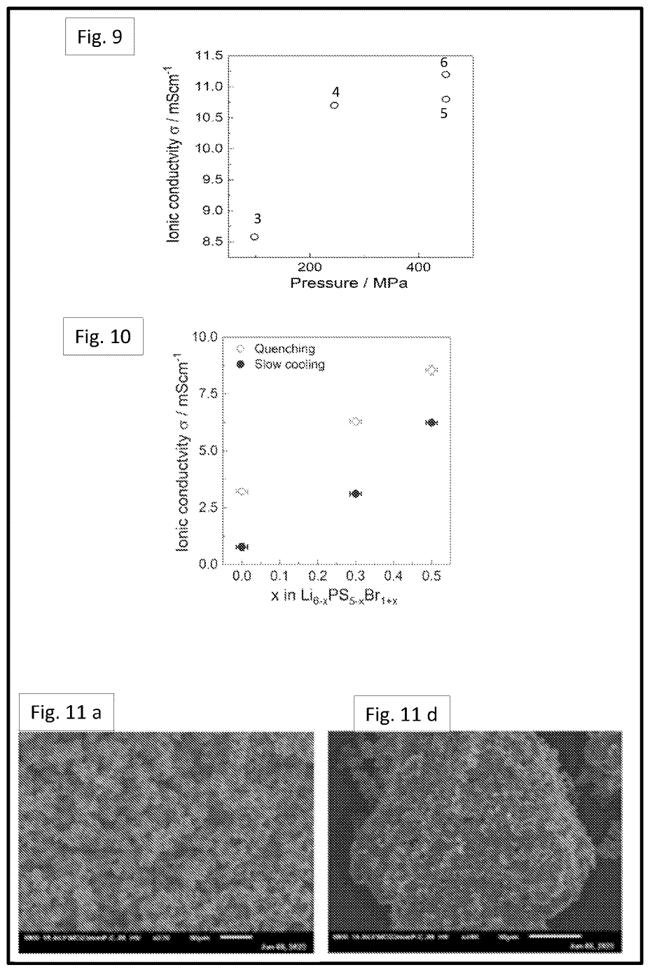

FIG. 9 demonstrates the ionic conductivity as a function of applied pressure in the synthesis method of the present invention.

The reference numbers 3, 4, 5 and 6 in FIG. 9 refer to the examples 3, 4, 5 and 6 as described in the figure description of FIG. 8. Example 3 was synthesized under pressure of 98 MPA, example 4 under 245 MPa and examples 5 and 6 under a pressure of 490 MPa.

In this particular example it concerns Li_{5.5}PS_{4.5}Cl_{1.5} electrolyte, which was synthesized under 98, 245 or 490 MPa respectively.

For the particular examples 3, 4, 5 and 6, synthesized under pressures of respectively 98, 245, 450 and 450 MPa, the resulting ionic conductivities were as follows:

| Pressure (MPa) | Ionic conductivity mS/cm |
|---|---|
| 98 | 8.58 |
| 245 | 10.7 |
| 450 | 10.8 |
| 450 | 11.2 |

It is demonstrated that when the electrolyte was synthesized either under 245 or under 490 MPa, the resulting electrolyte has a much higher ionic conductivity as compared to an electrolyte which was synthesized under a pressure of 98 MPa.

FIG. 10 demonstrates the ionic conductivity as a function of x in the general formula of the electrolyte Li₆₋ₓPS₅₋ₓBr₁₊ₓ. Ionic conductivity was determined for electrolytes wherein x was respectively 0 or 0.3 or 0.5. It is clearly demonstrated that with increasing value of x from 0 to 0.5, the ionic conductivity as determined increased accordingly. Additionally, it was found that the result was different depending on the particular way of cooling was applied: either a method step of slow cooling was applied, or a method step comprising quenching was applied. In both cases the ionic conductivity increased when x increased from 0 to 0.3 to 0.5. It is further demonstrated that after application of quenching, the resulting ionic conductivity of the particular electrolyte was higher compared to the electrolyte synthesized in a method wherein slow cooling was applied.

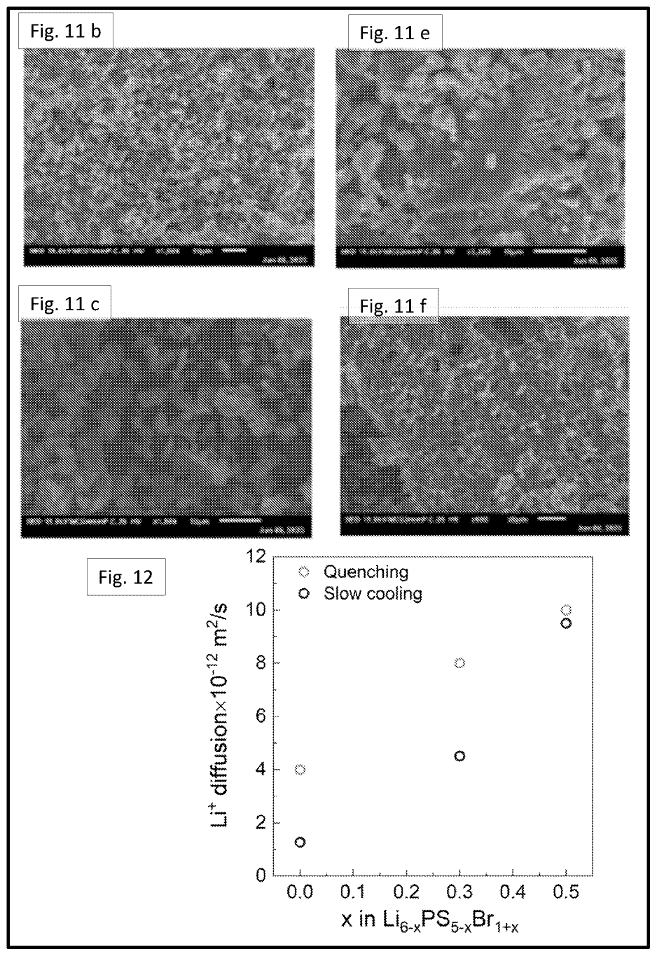

FIGS. 11a-c show SEM pictures of particle sizes of Li_{5.5}PS_{4.5}Cl_{1.5} as prepared according to the present method (milling for 10-25 min., heating to 400-500 °C for about 5 minutes, and quenching thereafter), and FIGS. 11d-f as prepared according to the prior art (milling during about 10 min, heating to 450-550 °C for about 7 days). The particle sizes according to the invention are from 200 nm to 2000 nm, and those of the prior art from 5 μm to about 100 μm, hence at least an order of magnitude larger.

FIG. 12 shows pulse field gradient NMR measurements. This shows promoted Li-ion diffusivity across the unit cell. The diffusion coefficient increased from 1.27×10⁻¹² m²/s (Li₆PS₅Br, slow cooling, lower symbols) to 1.01×10\hat{ }⁻¹² m²/s (Li_{5.5}PS_{4.5}Br_{1.5}, quenching, top symbols).

### EXPERIMENTS

In this study, an effect of halide substitution (Li₆₋ₓPS₅₋ₓBr₁₊ₓ, Li₆₋ₓPS₅₋ₓCl₁₊ₓ, Li₆SₓSi₁₋ₓS₅₋ₓI₁₊ₓ, in the range 0.0≤x≤0.5) on lithium argyrodite was investigated; also the structural disorder was engineered by changing the synthesis protocol. Additionally, this method was also applied to synthesize the halide mixed lithium argyrodite (Li₆₋ₓPS₅₋ₓHal₁₊ₓ, Hal=Cl, Br, I, Cl_{y}Br_{1-y}, and Cl_{0.33}Br_{0.33}I_{0.33} with a range of 0.0≤x≤0.5). Similar experiments are performed with Na, replacing Li, with As and Sb, each replacing P, and with O, replacing S. Experiments with Se and Te, replacing S, are planned. For the second structural argyrodite, A₆₊ₓZ₁₋ₓM₁₋ₓE₅₋ₓHal₁₊ₓ, similar results are obtained for A=Li or Na, the afore mentioned halogenides, for Z=P, and E=S. Experiments with Se and Te, replacing S, are planned. The obtained structural disorder was also found in the second structural argyrodite.

First, an argyrodite precursor was prepared via mechanical milling, followed by heat treatment at a particular temperature to obtain the crystalline argyrodite. Two different cooling methods were employed to influence the extent of structural disorder. Rietveld refinement of neutron diffraction patterns showed that this preparation method influences the structural disorder. It was found that higher ionic conductivity is correlated with a less negative charge on the 4d site, by replacing the S²⁻ with Hal⁻ (Hal=Cl, Br or I). An additional T4 Li⁺ site was identified in halide-based argyrodite. The result provided an increased ionic conductivity of ~8-12 (e.g. 9) mS cm⁻¹.

Mechanochemical Milling and Post-annealing: Li₆₋ₓPS₅₋ₓBr₁₊ₓ syntheses were performed under an argon atmosphere to prevent contamination of oxygen (O₂<2 ppm) and water (H₂O<1 ppm). Li₆₋ₓPS₅₋ₓHal₁₊ₓ, Hal=Cl, Br, I, Cl_{y}Br_{1-y}, and Cl_{0.33}Br_{0.33}I_{0.33} was synthesized using mechanochemical milling (Fritsch Pulverisette 7 premium line). The initial precursors; lithium sulfide (Li₂S, 99.98%) or likewise Li and S of 99.98% purity, lithium bromide (LiBr, 99.99%), and phosphorus pentasulfide (P₄S₁₀, 99%) were purchased from Merck and Sigma Aldrich. All precursors were mixed in an appropriate (or close to) stoichiometric ratio using a mortar and pestle. The obtained 1.0 g, 5 g, 10 g, of the precursor was then mechanochemically milled (20:1, 30:1, 40:1 mass ratio of milling media to precursors) using 3 mm, 5 mm, and 10-mm-diameter zirconia balls at 450-600 (e.g. 510) rpm for 10-30 min. The obtained powder was manually pressed into a 0.8, 1, 1.5-cm-diameter pellet and then placed inside quartz ampoules. The quartz ampoules were sealed under a vacuum (<10⁻³ mbar). The sealed quartz ampoules were placed inside a furnace for crystallization, and the furnace is preheated at a temperature of 450-550 °C for x=0.0 and 430 °C; for Li₆₋ₓPS₅₋ₓBr₁₊ₓ compositions. After a reaction time of 10⁻¹⁵ min, two different cooling methods were applied: (1) quenching in liquid water for fast cooling. (2) slow cooling using the cooling rate of 4 K/h for 4 days. The final powder was obtained, then hand-ground, and stored in an argon atmosphere glove box. The phase purity, lithium substructure, and ionic transport of the argyrodite series were analyzed by X-ray diffraction, neutron powder diffraction, and electrochemical impedance spectroscopy.

X-ray Diffraction: X-ray diffraction was carried out to determine the phase purities and relevant structural parameters with a X'Pert Pro X-ray diffraction (PaNalytical) in Bragg-Brentano θ-θ geometry with Cu Kα radiation (λ₁=1.540598 Å and λ₂=1.544426 Å, at 45 kV and 40 mA). Measurements were taken in the 20 range between 10° and 90°. All powders were placed on airtight sample holder with a Kapton lid under an argon atmosphere to prevent air exposure.

Neutron Powder Diffraction: Neutron powder diffraction data were collected on a neutron powder diffractometer PEARL at the research reactor of the TU Delft, operating at room temperature with the 533 reflection of the germanium monochromator (neutron wavelength of λ=1.667 Å).

Electrochemical Impedance Spectroscopy: Temperature-dependent electrochemical impedance spectroscopy was performed using an Autolab EC10M impedance analyzer with 0.01V amplitude with frequency ranging from 10 MHz to 1 Hz to determine the ionic conductivity of the samples.

Rietveld Refinement: The TOPAS software was used to perform Rietveld refinements of X-ray diffraction and neutron diffraction data. As a starting point for this study, earlier structural information obtained by neutron power diffraction of Li₆PS₅Br was used. The quality of the fits was determined using the goodness-of-fit (GOF) fit indicator and R_{wp}. The following parameters were refined: (1) 15 coefficients for a Chebyshev function were used to fit the background and peak shape modeled by the modified Thomson-Cox-Hasting pseudo-Voigt function, (2) scale factor, zero error, (3) lattice parameter, isotropic atomic displacement parameter, (4) atomic occupancies of the free S²⁻ (Wyckoff 4d) and Hal⁻ (Wyckoff 4a) anions, since these two anions can be exchanged. The occupancies of total occupancies of Hal⁻ and S²⁻ on the Wyckoff 4a site Wyckoff 4d site were constrained to one (occupancies of Hal⁻ (4a)+S²⁻ (4a)=1, occupancies of S²⁻ (4d)+Hal⁻ (4d)=1) assuming full occupancy of these sites by S²⁻ and Hal⁻. The stability of the refinements was ensured by allowing the refinement of multiple correlated parameters simultaneously. Finally, lithium occupancies on the possible interstitial sites as identified by the Fourier difference map (FDM).

From a crystallographic point of view Se, Te, and O can replace S in the mentioned Wyckoff locations, I and Cl may replace Br, Na may substitute/replace Li, and As and Sb may replace P.

### Results

Structural changes induced by Br content and synthesis method: Lithium argyrodite Li₆PS₅Hal, where Hal⁻ represents Cl, Br, or I, exhibits structural disorder between the Hal⁻ and S²⁻ positions, where higher disorder lead to faster Li-ion transport. Recently, it was discovered that structural disorder can be tuned in single composition Li₆PS₅Br via the synthesis method. Furthermore, replacing the S²⁻ with Br⁻ has been shown to increase ionic conductivity. A mechanochemical synthesis method was used to synthesize a series of Li₆₋ₓPS₅₋ₓBr₁₊ₓ materials (x≤0.5), the precursors were mechanically milled to ensure uniform mixing as reported previously, and then heated at different temperatures (550 °C for x=0.0, or 430 °C for X=0.3, and 0.5) for 10⁻¹⁵ min, which was sufficient to achieve crystalline lithium argyrodite. In order to control site disorder (in this case Br occupancy on 4d site), two distinct cooling methods were applied: (1) The material was cooled at a rate of 4 °C per h over several days to minimize Br occupancy on 4d site in each composition, (2) The material was quenched in liquid water (fast cooling) to achieve higher Br occupancy on 4d site. The quenching was expected to “freeze in” the higher Br occupancy on 4d site that was achieved at higher (synthesis) temperatures.

Samples contained minor impurity phases of less than 1.0 wt. %, with negligible impact on ionic transport or structural analysis. While increasing the Br and Cl and mixed Cl, Br and I content up to x=0.5, the cubic polymorphs are maintained. The analysis focused on the cubic polymorphs within the solubility limit (x≤0.5).

The Pawley-fit-refined lattice parameter of slow-cooled Li₆PS₅Br is a=9.98356 (7) It was found that if the Br content increases (higher x), the lattice parameter decreases for the slow cooling method and increases for the fast cooling method.

The lattice parameter as a function of the Br distributed across the Wyckoff 4a site was investigated. For the slow-cooling method, it was found that increasing the Br content does not affect the Br occupancy at the 4a site significantly. Hence the decrease in lattice parameter with increasing Br content maybe due to the increase in Li⁺ vacancies and/or differences in Li⁺ distribution. In the quenched sample, a clear trend was shown between the lattice parameter and Br occupancy in the 4a site. As the Br content increases, Br occupancy in the 4a site also increases, resulting in a larger lattice parameter.

The Br occupancy on the 4d site can be tuned in a single composition by adjusting the synthesis method. As the Br content (x) is increased, Br is distributed across the Wyckoff 4a and 4d sites in the crystal structure. The percentage of Br in 4d site obtained by the two different cooling methods as a function of total Br content was investigated. The slow-cooled sample was chosen as the lowest occupancies of Br in 4d site, determined by Rietveld refinements against neutron diffraction pattern. As the total Br content increases, the Br in 4d site also increases, starting from 12% at x=0.0 and reaching 63% at x=0.5 for the slow-cooled method. The quenched method has an even higher Br in 4d site, starting from 39% at x=0.0 to 72% at x=0.5, as fast cooling “freezes in” the higher Br in 4d site that is achieved at higher temperatures.

The Lithium substructure: As mentioned above, in the lithium argyrodite structure, the anion framework creates six different types of tetrahedral interstices, of which five of these may accommodate lithium. These tetrahedra are classified based on the number of shared corners, edges, or faces with adjacent PS₄³⁻ units, and are referred to as types 1 through 5 (T1-T5). The Li⁺ is found to occupy type 5 and type 2 (T5, T2, and T5a) positions, such as in Li₆PS₅Hal (Hal=Cl, Br, and I), forming cage-like structures around central anion (Wyckoff 4d). Also Li⁺ can partially occupy the T4 site (Wyckoff 16e), such as in Li_{6.15}Al_{0.15}Si_{1.35}S_{5.4}O_{0.6} and related Li₂S—SnS₂—SiS₂—P₂S₅ sulfides. The room-temperature high-symmetry F4̅3m structure of Li₆PS₅Br was used as a starting model. The occupancy of various Li sites in the argyrodite series by quenching and slow cooling method varies as a function of bromide content. Rietveld refinement revealed four Li+ sites that are occupied to different extents, which may vary in different compositions of Li₆₋ₓPS₅₋ₓBr₁₊ₓ: T5, T2, T5a, and T4. The overall Li⁺ content was found to be constrained to obtain a charge balance with the refined Br content. For compositions x=0.0-0.5 (quenching and slow cooling), the refined thermal displacement parameters of the T2 sites were relatively large compared to other Li⁺ sites in the structure (Bᵢₛₒ values of ~9 Å² for the T2 site) indicating a delocalization of the local motion of Li⁺ around the T2 site. The refined thermal displacement parameters of the T4 site were negative for slow-cooled x=0.0 compositions, Additionally, an FDM showed no visible evidence of Li occupation on the T4 site. When the Br content increases in slow-cooled compositions up to x≥0.3, additional T4 lithium sites were found. These sites were refined stably and excluding them from the model resulted in a worse fit. For example, when T4 sites were excluded in x=0.3, it led to an increase in R_{wp} from 6.4 to 7.0%.

It was found that the T2, T5, and T4 polyhedral volumes are barely affected by change in Br content. BVSE landscapes of Li₆₋ₓPS₅₋ₓBr₁₊ₓ revealed that cage-to-cage Li+ diffusion pathways are more connected with higher Br content The T2-T2 and T5-T4-T5 distance as a function of bromide content using both slow-cooling and quenching methods was investigated. The slow-cooled Li₆PS₅Br composition only allows for lithium-ion diffusion through T2-T2 pathways, no occupancy of T4 site is observed. As the bromine content increases, the T2-T2 distance remains constant for the slow-cooled method and decreases for the quenching method. The T5-T4-T5 distances decrease with increasing bromide content in both synthesis methods. With increasing bromide content in the slow-cooled method, the T5-T4-T5 distance decreases from 3.76 (10) Å at x=0.3 (composition) to 3.6 (9) Å at x=0.5. In the quenched method, the T5-T4-T5 distance decreases from 3.64 (12) Å at x=0.0 to 3.49 (8) Å at x=0.5. Summarizing, as bromide content increases the T5-T4-T5 inter-cage distance decreases for both slow and quenched colling and the T2-T2 inter-cage distance reduces only for the quenched cooling, potentially promoting the long-range diffusion, especially for the quenched cooled materials.

The average charge on the Wyckoff 4a and 4d sites may vary based on their occupancy, due to the different charges of Br⁻ and S²⁻. To quantify how Br⁻ impacts the arrangement of calculating the average distance between the 4d site (central anion, S²⁻) and Li⁺ located at different sites (T2, T5, and T5a), weighed by the occupancy of each site within a single cage, as previously introduced. Along a series of changing total Br content and Br occupancy on 4d site, significant deviations of Rₘₑₐₙ are observed. This result is supported by room temperature ⁶Li NMR spectra of Li₆₋ₓPS₅₋ₓBr₁₊ₓ. The spectrum for Li₆PS₅Br with a lower Br occupancy on 4d site displays an intense resonance at 1.615 ppm assigned to Li⁺ atom occupying the T2, T5, and T5a sites. Inventors observed that with increasing Br⁻ content, the ⁶Li resonance shifts towards a higher field and smaller ppm values. This shift to lower ppm values indicates that Li-atoms are experiencing a more electron-rich environment. As the amount of Br on the 4d site increases, either through increase of the Br content, the average negative charge on the 4d site decreases as the divalent sulfide is replaced by monovalent Br. To examine the effect of varying total Br content and Br 4d occupancy on the ionic conductivity of Li₆₋ₓPS₅₋ₓBr₁₊ₓ, temperature-dependent impedance spectroscopy was performed to measure ionic conductivity and activation energy. The impedance data at lower temperatures (−40 to 25 °C) were fitted with a resistor and constant phase element (CPE) in parallel. The CPE in parallel exhibited a capacitance of around 1 to 8×10⁻¹⁰ F cm⁻² and an α value of 0.89-0.97, indicating bulk transport, respectively. The ionic conductivities at room temperature vary as a function of Br content. The ionic conductivity increases with Br content for both cooling methods. As shown, higher site disorder (in this case Br occupancy on 4d site) leads to an improvement in ionic conductivity. The conductivity of slow-cooled Li₆PS₅Br sample (12% Br occupancy on 4d site) was 0.78 mS cm⁻¹. The conductivity of the slow-cooled samples increased from 0.78 mS cm⁻¹ to 6.2 mS cm⁻¹ with increasing Br content, while the conductivity of quenched samples increased from 3.21 mS cm⁻¹ to 8.55 mS cm⁻¹ with increasing Br content.

Structure—Property Relationship: Increasing the Br occupancies in 4d site by changing the synthesis method can significantly improve the ionic conductivity in lithium argyrodites. Inventors were able to tune the Br occupancies in 4d site and lithium substructure in each composition. Certain observations are:
As the total Br content increases, the Br occupancies in 4d site also increases, starting from 12% to 63% for the slow-cooled method. The Br occupancies in 4d site is higher at higher temperatures and quenching can kinetically “freeze in” the higher Br occupancies in 4d site. The quenched method is found to have an even higher Br occupancies in 4d site, ranging from 39% to 72%. Overall, this work highlights the importance of synthesis methods as a tool control Br occupancies in 4d site in the lithium argyrodites.
In the lithium substructure, a non-zero T4 occupation was found.
As the Br occupancies in 4d site increases in both cooling methods (see in above section), the average negative charge on the 4d site decreases as the divalent sulfide is replaced by monovalent bromide ion. This results in a higher overall conductivity.
For the slow-cooled samples, inventors found an increase in the ionic conductivity from 0.78 to 6.20 mS cm⁻¹.
   For quenched samples, an increase in ionic conductivity from 3.21 to 8.55 mS cm⁻¹ was found.

### Higher Halide Concentrations

Synthesis of small grain size glass ceramic Li₅PS₄Cl₂, Li₅PS₄Br₂, and Li₅PS₄I₂ were prepared according to the present method and shows ionic conductivities of 1.0 mS/cm, 2.75 mS/cm, and 8.23 mS/cm, respectively.

List of Possible Anodes and Cathodes where this could be Applied:

### Anodes:

Alloy anodes (such as Aluminium (Al), Tin (Sn), Magnesium (Mg), Silver (Ag), Antimony (Sb), and their alloys).
Conversion-type anode materials include transition-metal sulphides, oxides, phosphides, nitrides, fluorides, and selenides.
Silicon-based compounds
Carbon based compounds
Li/Na metal anode

### Cathode:

LiFePO₄
LiFeₓMn₁₋ₓPO₄
LiMn₂O₄ spinel
LiNi_{0.5}Mn_{1.5}O₄ spinel
LiNiₓCo_{y}Mn_{1-x-y}O₂ layered oxides
Li-rich layered oxides

For experimental results reference is also made to an article submitted for publication, titled “Exploring the Relationship Between Halide Substitution, Structural disorder, and Lithium Distribution in Lithium Argyrodites Li₆₋ₓPS₅₋ₓBr₁₊ₓ”, which article and its content is incorporated by reference.

1. An electrolyte for a solid-state battery comprising
at least one solid single crystalline electrolyte wherein the solid single crystalline electrolyte is selected from at least one of A₆₋ₓZE₅₋ₓHal₁₊ₓ and A₆₊ₓZ₁₋ₓM₁₋ₓE₅₋ₓHal₁₊ₓ, wherein A is selected from Li, Na, and first combinations thereof, wherein Z is selected from P, As, Sb, and second combinations thereof, wherein M is selected from Si, As, Ge, Sn, and Sb, and third combinations thereof, wherein E is selected from O, S, Se, Te, and fourth combinations thereof, wherein Hal is selected from Cl, Br, I, and fifth combinations thereof, and wherein x is from <−1;1.0].

2. The solid electrolyte according to claim 1, wherein the solid electrolyte is in the form of single crystalline particles, wherein the particles have a size distribution with an average size of 200-5000 nm, and wherein a standard deviation of the size distribution is 2-20% relative to the average size, as measured with a Shimadzu SALD-7500nano.

3. The solid electrolyte according to claim 1, wherein the solid electrolyte is a mixed crystal.

4. The solid electrolyte according to claim 3, wherein at least one of first combinations, second combinations, third combinations, fourth combinations, and fifth combination is present.

5. The solid electrolyte according to claim 1, wherein a unit cell of the solid electrolyte comprises a plurality of crystallographic Hal-sites, respectively, wherein a first of said crystallographic Hal-site is partly occupied by E and Hal, wherein Hal-sites are a Wyckoff 4a Hal-site and a Wyckoff 4d Hal-site, having a crystal site Hal distribution wherein a first site is occupied for up to 95%, wherein a second site is occupied for more than 5%.

6. The solid electrolyte according to claim 1, wherein the solid single crystalline electrolyte has at least one site disorder of 1-75%.

7. The solid electrolyte according to claim 1, wherein the solid single crystalline electrolyte has an ion conductivity of >1 mScm⁻¹.

8. The solid electrolyte according to claim 1, wherein the solid single crystalline electrolyte has a crystallinity of >95%, and
wherein the unit cell of the solid single crystalline electrolyte has a plurality of A-crystal sites, wherein A-crystal sites are selected from a Wyckoff T2-site, a Wyckoff T4-site, a Wyckoff T5a site, and a Wyckoff T5 site, wherein at least two of the plurality of A-crystal sites are one of partly and fully occupied by A, and having a crystal site A distribution wherein a first site is occupied for more than 55%, wherein a second site is occupied for 1-25%, wherein a third site is occupied for less than 26%, and wherein a fourth site is occupied for a remainder of the A-occupation, as determined with neutron diffraction data,
wherein solid single crystalline electrolyte has a capacitances of 0.1 to 20×10⁻¹⁰ F cm⁻², and
wherein solid single crystalline electrolyte has a bulk transport representing α value of 0.89-0.97.

9. A solid state battery comprising
at least one first electrode,
at least one second electrode,
in between the first and second electrode and in contact with the first and second electrode at least one solid state single crystalline electrolyte according to claim 1.

10. The solid state battery according to claim 9, wherein the material of the cathode is selected from Fe comprising cathodes, from Mn comprising cathodes, from Li and Na comprising cathodes, from Co comprising cathodes, from transition metal alloys, from Ni comprising cathodes, from nickel comprising alloys with >75% Ni, and wherein the anode comprises a material selected from alloys, from Al-alloys, from Sn-alloys, from Mg-alloys, from Ag-alloys, from Sb alloys, from In alloys, and from silicon alloys (a-Si_{y}Aₓ:Q_{z}), wherein element A is selected from B, C, N, Ge, O, and combinations thereof, wherein element Q is selected from H, F, and combinations thereof, and from silicon, wherein the silicon alloy er and silicon is porous for accommodating electrolyte ions, wherein the silicon alloy and silicon has a porosity from 1-50%, wherein the silicon alloy and silicon is amorphous, from conversion-type anode materials, from metal sulphides, from metal oxides, from metal phosphides, from metal nitrides, from metal fluorides, and from metal selenides, from carbon based compounds, and from a Li- and Na-metal anode.

11. The solid state battery according to claim 9, wherein the at least one first electrode and the at least one second electrode comprise a nano-crystalline material.

12. The solid state battery according to claim 9, wherein the battery further comprises at least one separator, wherein the at least one separator is provided in between the at least one solid state crystalline electrolyte and one of the first and second electrode, respectively.

13. The solid state battery according to claim 9, wherein the at least one first electrode has a thickness of 50-500 μm, and wherein the at least one second electrode has a thickness of 20-300 μm and
wherein the at least one solid state crystalline electrolyte has a thickness of 100-1000 μm.

14. A method of producing a solid crystalline electrolyte according to claim 1, wherein the to be produced solid electrolyte comprises at least one of A₆₋ₓZE₅₋ₓHal₁₊ₓ and A₆₊ₓZ₁₋ₓM₁₋ₓE₅₋ₓHal₁₊ₓ, wherein A is selected from Li, Na, and first combinations thereof, wherein Z is selected from P, As, Sb, and second combinations thereof, wherein M is selected from Si, Ge, As, Sn, and Sb, and third combinations thereof, wherein E is selected from O, S, Se, Te, and fourth combinations thereof, wherein Hal is selected from Cl, Br, I, and fifth combinations thereof, and wherein x is from <−1;1.0], wherein x is not from −0.99 to −1,
providing precursors in substantially molar amounts and forming a mixture thereof, wherein precursors are selected from A, M, Z, E, combinations of ZE, and from AHal,
wherein E is provided in an excess amount of 1.01-1.2 times the molar amount,
milling the mixture during a milling time therewith obtaining a milled mixture,
heating the milled mixture at an elevated temperature during a heating time therewith forming electrolyte, and
cooling the heated mixture therewith obtaining solid crystalline electrolyte.

15. The method according to claim 14,
wherein the milling time is from 10⁻⁶⁰ minutes, and
wherein milling is performed at a rpm of 500-600 rpm, and
forming pellets under a pressure, during a pressure time of 10-60 seconds,
wherein the milled mixture is heated to a heating temperature of 400-550 °C, and during a heating time of 5-120 minutes, and/or
wherein cooling is from the heating temperature to a temperature of 15-30 °C, during a cooling time of 1-30 seconds.

16. The method according to claim 14, wherein the heating temperature is from 300-750 °C, and the heating time is from 1-10 minutes, wherein a pre-heated oven at the heating temperature is used.

17. The method according to claim 14, wherein the precursors are selected according to
A is selected from Li, Na, and first combinations thereof,
Z is selected from P, As, Sb, and second combinations thereof,
M is selected from Si, Ge, Sn, and Sb, and third combinations thereof,
E is selected from S, Se, Te, and fourth combinations thereof,
Hal is selected from Cl, Br, I, and fifth combinations thereof,
wherein precursors are selected from Li, P, S, Si, Cl, Br, and I, and combinations of A, Z, M, E, and Hal, and with the proviso that Li₂S is not selected.

18. A product obtained by the method of claim 14, wherein the product is crystalline.

19. A system for power supply comprising a part selected from at least one solid-state battery according to claim 9 and at least one product according to claim 18.
